(19) United States
(12) Patent Application Publication
(10) Pub. No.: US 2019/0063884 A1
(43) Pub. Date: Feb. 28, 2019

(54) SYSTEMS AND METHODS FOR AUTOMATED SHOOTING EVALUATION

(71) Applicant: Downrange Headquarters, LLC, Springville, UT (US)

(72) Inventors: Nathan Travis McBride, Orem, UT (US); Michael Clark Graham, Mapleton, UT (US)

(21) Appl. No.: 16/111,639

(22) Filed: Aug. 24, 2018

Related U.S. Application Data
(60) Provisional application No. 62/549,867, filed on Aug. 24, 2017.

(51) Int. Cl. F41J 5/10; F41J 5/14; G06T 7/70

(52) U.S. Cl. CPC F41J 5/10; F41J 11/00; G06T 7/70; F41J 5/14

(57) ABSTRACT

Systems and methods are provided for automated evaluation of performance of a shooter at a shooting range. An automated shooting evaluation system may include a target carrier, a vision system, a control computer, and a user interface. The target carrier can secure a target. The vision system can be fixed relative to the target carrier to capture image data of a target secured by the target carrier and can include an imaging device and processor(s) to receive and process image data captured by the image device to identify the target and, further, to identify changes to the target. The vision system can transmit a position of a detected bullet hole to the user interface, which can display a bullet hole indicator superimposed on a digital representation of the target. An automated shooting evaluation system can also include a shot-fired detector to detect whether a shot is fired at the target and to communicate shot-fired detection data to the user interface.

### RELATED APPLICATIONS

This application claims the benefit of priority U.S. Provisional Application No. 62/549,867, filed Aug. 24, 2017, entitled SYSTEMS AND METHODS FOR AUTOMATED SHOOTING EVALUATION, which is hereby incorporated by reference herein in its entirety.

### TECHNICAL FIELD

This disclosure relates generally to shooting range equipment. More specifically, this disclosure relates to systems and methods for automated evaluation of performance of a shooter at a shooting range.

### BRIEF DESCRIPTION OF THE DRAWINGS

Non-limiting and non-exhaustive embodiments of the disclosure are described, including various embodiments of the disclosure with reference to the figures, in which:

FIG. 1 is a perspective view of a plurality of firing lanes of a shooting facility including an automated shooting evaluation system (“ASES”), according to an embodiment of the present disclosure.

FIG. 2 is a partial network diagram of a shooting facility including an ASES, according to an embodiment of the present disclosure.

FIG. 3 is a view of a firing lane of the shooting facility of FIGS. 1 and 2 including an ASES, according to an embodiment of the present disclosure, from behind a firing position of the firing lane and toward a target.

FIG. 4 is a side view of the firing lane of FIG. 3, according to an embodiment of the present disclosure.

FIG. 5 is a cross sectional view of the target carrier of FIGS. 3 and 4.

FIG. 6A is a cross sectional side view of a drive unit of the firing lane of FIGS. 3-4, according to an embodiment of the present disclosure.

FIG. 6B is a close-up side view of the processor of FIG. 6A.

FIG. 7 is a front view of a target for use with an ASES, according to an embodiment of the present disclosure.

FIG. 8A is a front view of a user interface of an ASES comprising a touch screen, according to one embodiment of the present disclosure.

FIG. 8B is a front view of a user interface of an ASES having physical buttons to control the target platform, according to an embodiment of the present disclosure.

FIG. 9A is a front view of a target with three bullet holes.

FIG. 9B is a perspective view of the target of FIG. 9A as viewed by the vision system of an ASES, according to an embodiment of the present disclosure.

FIG. 9C is a perspective view of the target of FIGS. 9A-9B from the view of a shooter at the firing of FIGS. 3, 4.

FIG. 9D is front view of a user interface of an ASES, according to an embodiment of the present disclosure, displaying the target of FIGS. 9A-9C.

FIG. 10 is a flow diagram for the method for automatically evaluating shooting performance, according to an embodiment of the present disclosure.

### DETAILED DESCRIPTION

Shooting ranges are generally used by professional, competitive, and recreational shooters to practice firearm handling or shooting techniques, or for formal competitions relating to the same. Regardless of a shooter's purpose or objective for a particular shooting session, a shooter often uses a mechanical carrier to send and return a physical target (“target”) down range and up range in the course of a shooting session. Thus, a shooter may easily send a target to various distances and shoot the target. This distance between the firing line and the target is often understood as a “firing distance.”

After shooting the target, recognition of a given bullet hole location is often difficult because the distance to the target can be considerable, making identification of bullet holes difficult with the naked eye. Thus, the shooter will frequently return the target up range to more easily evaluate the bullet holes' location and determine shooting performance (“Manual Target Evaluation”), and may also manually calculate the target score (“Manual Score Calculation”). Finally, a shooter will use their Manual Target Evaluation and/or Manual Score Calculation to help inform their shooting performance. It should be noted that in non-competitive environments, a target score is ultimately based solely on the shooter's performance claims, and the major components of the score (i.e., Firing Distance, number of shots actually taken, etc.) are subjectively claimed by the shooter, without objective confirmation thereof.

As more bullet holes are created on the target, identification of the bullet holes becomes even more difficult as the shooter can no longer recognize or remember which of the many bullet holes—often densely grouped—belonged to a particular shot. Thus, the shooter will frequently replace the target to more easily identify their next bullet hole locations.

Furthermore, during shooting competitions, manual target evaluation and manual score calculation can be time-consuming. In some instances, to help mitigate the time demand, shooters may be required to retrieve their own targets for delivery to a judge; however, this introduces the possibility of target mishandling, resulting in erroneous evaluation and score calculation.

The present inventors have recognized that presently available technologies in shooting ranges lack automated target evaluation and/or automated performance analysis.

The disclosed embodiments provide automated target evaluation, automated score calculation, and/or automated performance analysis. The disclosed embodiments may further include a shot-fired detection unit, which can further enhance the functionality.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

The term “range” as used herein refers to a facility, indoor or outdoor, designed and equipped for the purpose of accommodating firearm training, handling, and shooting. Within the field of marksmanship, “range” may also mean the distance a firearm projectile may travel; however, the term is not used in that sense herein.

The term “range operator” refers to an entity, owner, manager, employee, or any range officer having operational control of the range. “Range officer” has the meaning common to the field of marksmanship.

The term “firing line” has the common meaning within the field of marksmanship; ergo, a “firing line” is (a) a line demarking a region of a range beyond which the muzzle of any weapon is intended to be located when the weapon is discharged. “Firing line” may also refer to a series (or row) of discrete positions located immediately adjacent to that demarking line wherein shooters are intended to be located while handling and discharging weapons.

The term “firing position” refers to a discrete position within the series (or row) of discrete positions located adjacent to the demarking firing line. While it is common in the field of marksmanship to use the term “firing position” to also refer to the specific bodily position of a shooter while shooting, the term will not be used in this sense herein (see “stance”).

The term “target” refers to any of a collection of objects which serves as an intentional objective of a shooter when shooting. For the purposes of this disclosure, a “target” generally includes an image printed or otherwise affixed to a target sheet or a similar surface and placed at a distance from the firing line in a direction intended for firing. In other words, “target” can refer to an image and the sheet or other surface to which the image is affixed for the purpose of marksmanship. A target sheet typically is a type of paper, but may also be wood, metal, or any other appropriate surface. The distance of the target from the firing line may vary according to the purpose of the shooter, event, or event stage. A target may include a scoring region (with or without scoring marks) and a non-scoring region. A target may also include various other marks such as, for example, identifying marks.

The term “firing lane” refers to an area within a range comprising a firing position and its associated target, along with the space between the firing line and the backstop behind the associated target. By way of example, when a firing position is equipped with a wall to either side, visually extending the walls to the target and beyond the target to the backstop illustrates a firing lane.

The term “firing distance” refers to the distance from the firing line to a target. The firing distance may vary according to the purpose of the shooter, event, or event stage.

The term “backstop” refers to an area of a range intended for receiving ballistic projectiles (see “bullet”) after discharge, and which is located at a position beyond the maximum firing distance intended for targets on the range.

The term “down range” is a directional reference indicating a direction generally from the firing line toward the backstop. Similarly, the term “up range” is a directional reference indicating a direction generally from the backstop toward the firing line.

The term “cartridge” refers, generally, to a single unit of ammunition for a firearm. More specifically, a “cartridge” comprises a “bullet,” a “casing” (also known as a “cartridge casing”), gunpowder, and a primer. The casing is that component of a cartridge which contains the gunpowder and incorporates in some form the primer, and to which a bullet is coupled so as to be fixed to the casing until the cartridge is discharged. “Bullet” refers to a ballistic projectile, meaning that portion of a cartridge designed to detach from the cartridge upon discharge and, when discharged from a firearm, to travel along and within the firearm's barrel until reaching the muzzle of the barrel and then continuing onward in the direction in which the barrel is pointed at the moment of discharge.

The term “bullet hole” refers to a change in the surface of a target resulting a bullet striking, penetrating, and passing through the target. A bullet hole may have identifiable characteristics such as circularity, concavity, tears in the target surface (generally within the circularity of the specific bullet hole), and residue from the bullet itself or lubricant on the bullet (often known as “swipe” or “bullet swipe”).

The term “group” (also, “grouping”) refers to a collection of bullet holes on a target, generally fired in a corresponding series. For example, a shooter may fire five shots in an uninterrupted series at the same target producing a collection of five bullet holes, which bullet holes are a group.

The term “stance” refers to the physical positioning of the shooter's body preparatory to and while firing a firearm. In the field of rifle and pistol shooting, “stance” generally refers to a standing position having identifiable, repeatable characteristics such as foot position, hip position, grip on the weapon, arm position, and so forth. By way of example, a pistol shooter's stance may be a Weaver Stance, a Chapman Stance, an Isosceles Stance, and a Retention-Position Stance, among others.

The term “accuracy,” and, similarly, “accurate” and “accurately,” refers to a degree to which a shooter is able to place bullets at or near a point of aim on a target. Generally, the nearer a bullet hole is to an intended point of aim, e.g., the center of a “bullseye” target, the greater the accuracy.

The term “precision,” and, similarly, “precise” and “precisely,” refers to a degree to which a collection of shots produces a group on a target. For example, a group of bullet holes spread widely across a target lacks precision. Conversely, a group of bullet holes close enough together to be covered by a quarter (U.S. 25 cent coin) may reflect substantial precision.

The term “score calculation” refers to evaluating the accuracy of a shooter's performance by assessing the location of bullet holes on a target with respect to scoring parameters for the type of target. Score calculation refers to the score achieved (see “target evaluation” for contrast). For example, when employing a target NRA B-8 Official 25-Yard Timed and Rapid Fire Pistol Target, a commonly used pistol bullseye target, score calculation determines the score ring nearest the center impacted by each bullet hole, with the values of all the holes for a stage or event added together to establish a score. An NRA B-8 target or a target substantially the same as the NRA B-8 has score rings ranging in value from 5 points to 10 points, and X points. Each ring is demarked by a fine-lined ring circumscribing the outer edge of each score value ring. The score value ring furthest from the target center has a value of 5, the next nearer ring has a value of 6, and so forth, until the ring next-nearest the center, which has a value of 10. The center of the target is X. A bullet hole is given the value of the highest score value ring touched by the bullet hole. The X is counted for each bullet hole touching the X ring; however, the number of Xs achieved is employed only to break a tie score between two or more shooters. Targets having other forms (non-bullseye) may be similarly scored.

The term “target evaluation” refers to evaluating the precision of a shooter's performance by assessing a group of bullet holes on a target.

The term “performance analysis” refers to evaluation of a shooter's performance by assessing both the accuracy and precision of a group of bullet holes on a target. While a score calculation focuses on a shooter's score, a target evaluation focuses on a shooter's precision. Performance analysis is a connection between accuracy and precision with the view that a shooter, generally, may perform with consistently greater accuracy by evaluating and improving his/her precision.

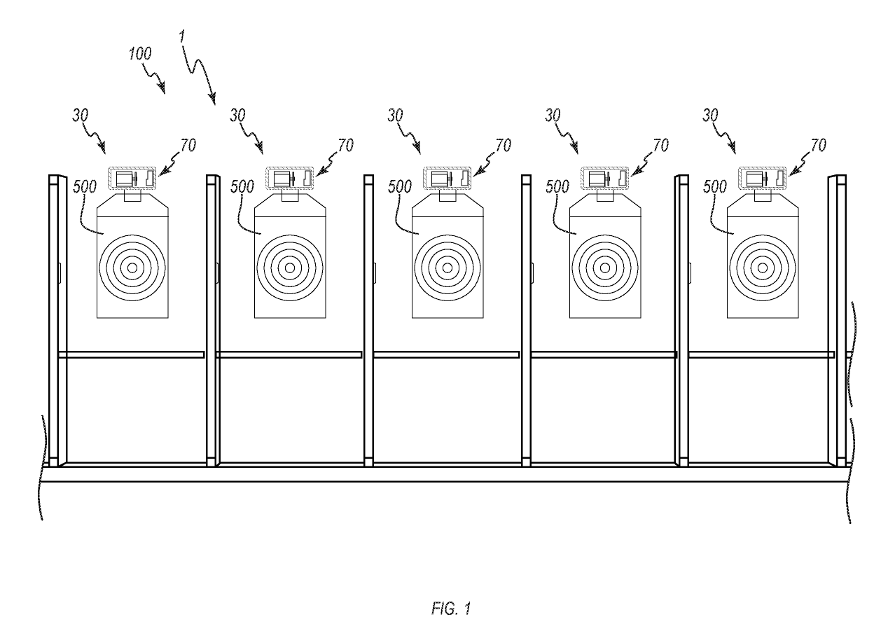

FIG. 1 is a perspective view of a plurality of firing lanes 30 of a shooting facility 1 having an automated shooting evaluation system (“ASES”) 100, according to an embodiment of the present disclosure. Each firing lane 30 comprises a target platform 70. The target platform 70 of each firing lane 30 has a target 500 attached. Although FIG. 1 illustrates a shooting facility 1 with five firing lanes 30, the present disclosure anticipates a shooting facility 1 having more or fewer firing lanes 30.

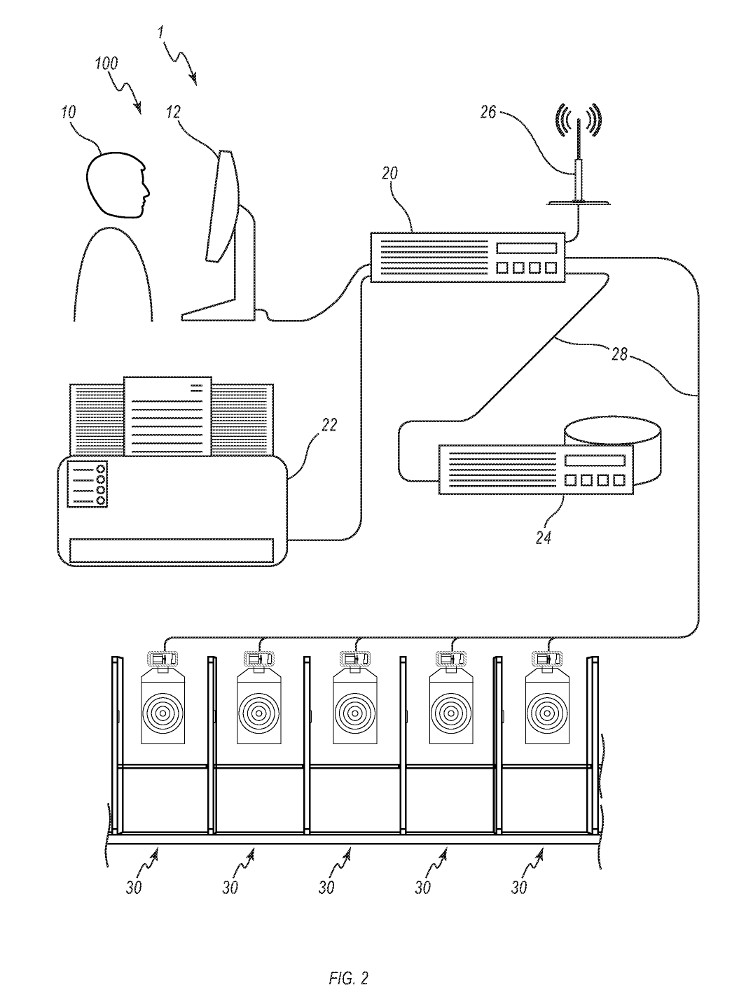

FIG. 2 is a partial network diagram of the shooting facility 1 having the ASES 100, according to an embodiment of the present disclosure. The ASES 100 comprises a range operator interface 12, a control computer 20, a data storage system 24, and one or more firing lanes 30. The control computer 20 may communicate to each of the other components of the ASES 100 wirelessly 26 or via wired connections 28. A range operator 10 (e.g., an employee of the shooting facility 1) may interact with the control computer 20 through the range operator interface 12. The range operator interface 12 may be used to access the data storage system 24 through the control computer 20, to update data on the data storage system 24, to add data to the data storage system 24, etc. Data may also be added to or updated on the data storage system 24 by the control computer 20 as a result of input received from other components of the ASES 100, as described below. Data on the data storage system 24 may comprise records associated to individual shooters (e.g., identification information), current event data, historical event data, and more. The ASES 100 may include one or more printers 22. The printer(s) 22 may print, for example, current event data for an individual shooter, historical event data for an individual shooter, current event data for a plurality of shooters (such as members of a marksmanship class, or participants in a competitive event, for example), targets, target identifiers, etc.

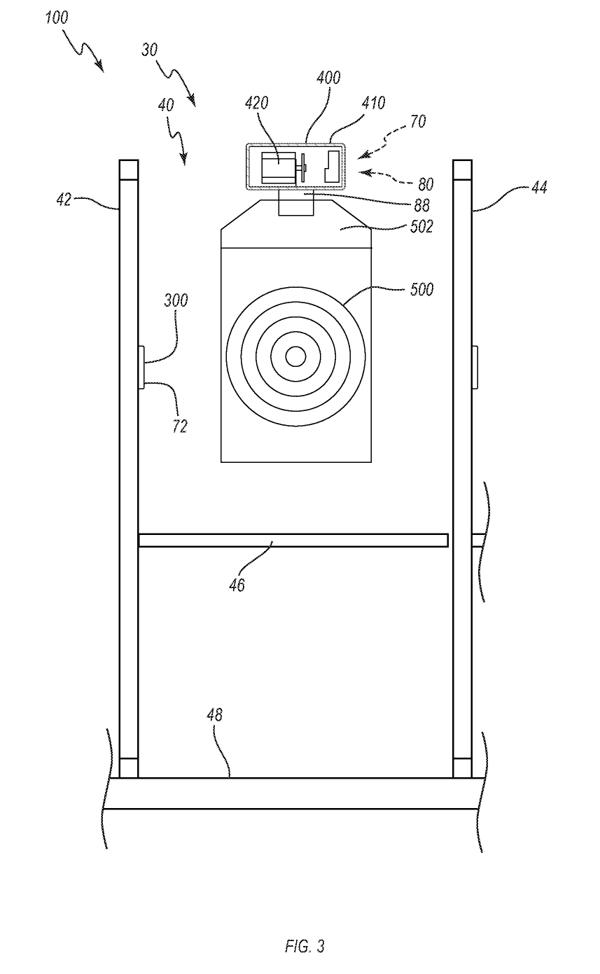

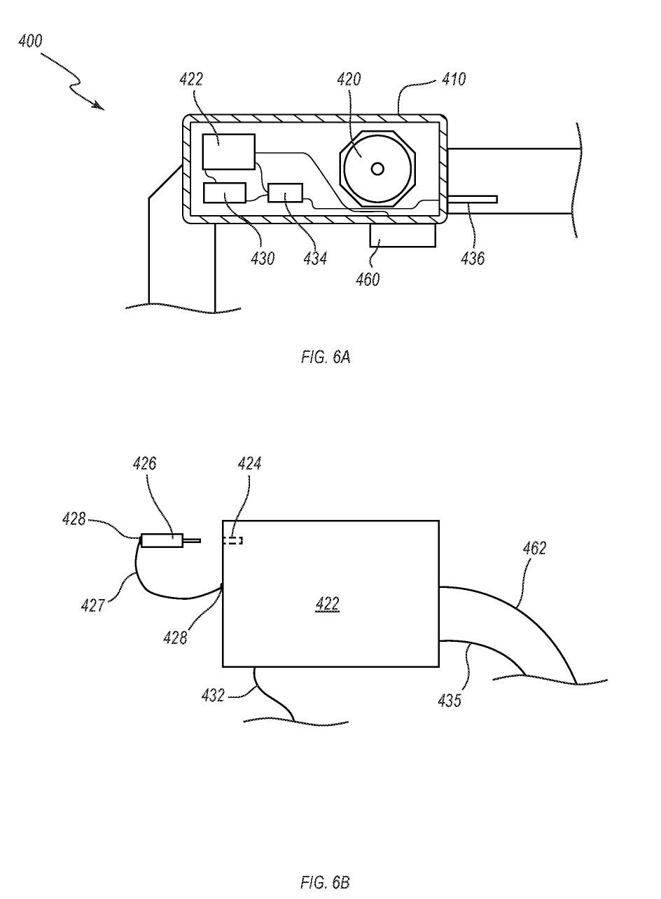

FIG. 3 is a view of a firing lane 30 of the shooting facility 1 of FIGS. 1 and 2 including an ASES 100, according to one embodiment. The view of FIG. 3 is from behind a firing position 40 of the firing lane 30 and toward a target 500 in the firing lane 30 down range a distance from the firing position 40. The firing lane 30 comprises the firing position 40, a firing line (not shown, but see, e.g., firing line 32 in FIG. 4), a target platform 70, a drive unit 400, a region of a floor 48, two stall walls 42, 44, target platform control(s) 72, and a user interface 300. An end (left-most or right-most) firing lane 30 may have a single stall wall, either 42 or 44. The firing lane 30 may optionally include a shot-fired detector (not shown, but see, e.g., 460 in FIG. 6A). A backstop may be located distal to the firing position 40 (e.g., down range beyond the target platform 70). The backstop may be a shared feature of all firing lanes 30 at the shooting facility 1, or may be specific to an individual firing lane 30.

The firing position 40 is that region of the firing lane 30 wherein a shooter (not shown) is to be located while handling a firearm (not shown). The firing position 40 can be demarked at the distal edge (toward the target 500) by the firing line (see firing line 32 in FIG. 4) and at the lateral sides by the left and right stall walls 42, 44 (when present). The proximal limit of the firing position 40 (e.g., a proximal transition from the firing position 40 to an area behind the firing position 40) may be any feature chosen or designated by a range operator, e.g., a painted line, a step, a difference in floor surface, etc. By way of example, the firing position 40 may include an elevated floor 48, or a line (not shown) may be painted on the floor 48 at a location somewhat rearward of the firing position 40. The firing position 40 may include a shooter's bench 46.

The target platform control(s) 72 may include one or more buttons and/or switches. When activated, the target platform control(s) 72 may cause the target platform 70 to move down range away from the firing position 40 or up range toward the firing position 40; or to move from one firing distance to another firing distance; or to rotate from a position orthogonal to the firing line (see firing line 32 in FIG. 4) to a position parallel to the firing line 32, and from the firing line-parallel position to the firing-line orthogonal position. In FIG. 3, the target platform control(s) 72 are shown coupled at the left stall wall 42. In some embodiments, the target platform control(s) 72 may be coupled at a different location within the firing position 40, e.g., at the right stall wall 44, or at the shooter's bench 46. In another embodiment, the target platform control(s) 72 may be incorporated into, or coupled at, the ASES user interface 300.

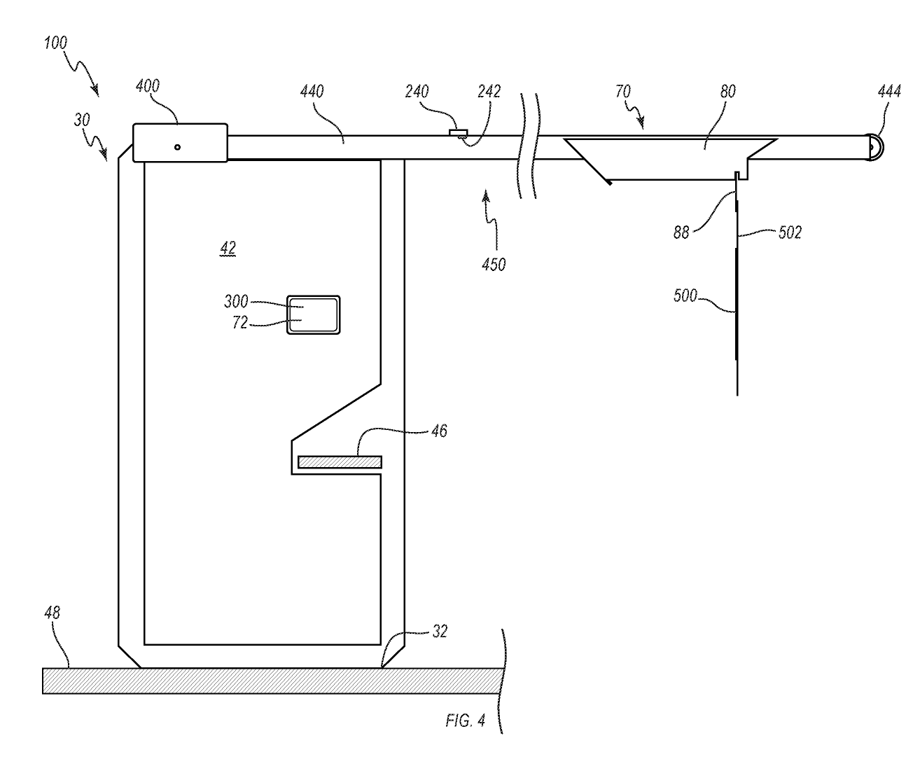

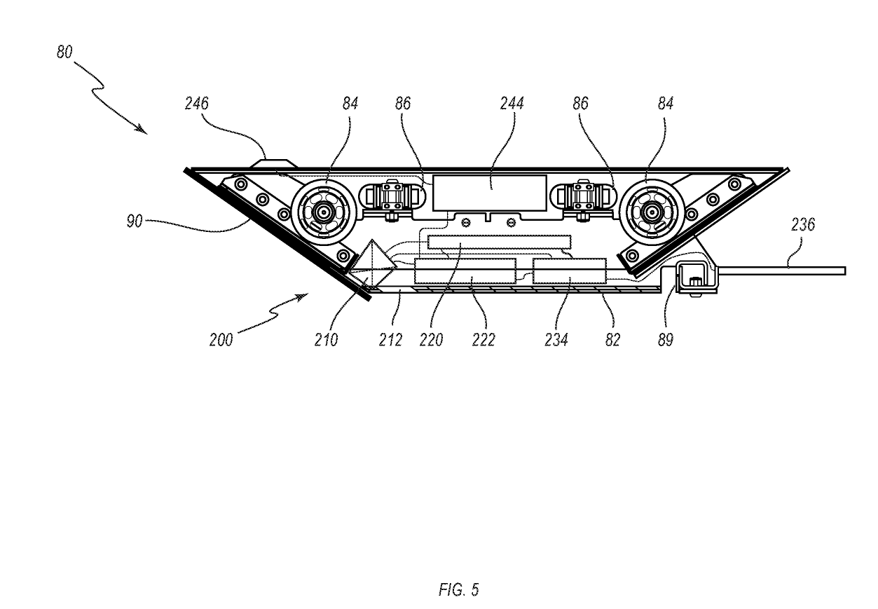

The target platform 70 may include a target carrier 80 and a target hanger 88 and related components, including, but not limited to, those to couple the target carrier 80 to a track (not shown, but see, e.g., track 440 in FIG. 4). In some embodiments, the target carrier 80 may include components to manipulate the target 500. For example, the target carrier 80 may include components to receive and transport the target 500 with the target 500 disposed orthogonal to the firing line (see firing line 32 in FIG. 4), and to articulate, or rotate, the target 500 to a position parallel to the firing line 32, as well as to articulate or rotate the target 500 from a position parallel to the firing line 32 to be disposed orthogonal to the firing line 32. The target platform 70 may include at least some components of the ASES 100, such as a vision system (not shown, but see, e.g., vision system 200 in FIG. 5). The target hanger 88 may couple a target 500 to the target carrier 80. While a bullseye target 500 is depicted in FIGS. 1, 3, et seq., the target hanger 88 may couple any of a variety of target types suitable to a given shooting purpose.

The target carrier 80 of the target platform 70 further comprises a track (not shown, but see, e.g., track 440 in FIG. 4) and a drive unit 400, and an end pulley (not shown, but see e.g., end pulley 444 in FIG. 4). The drive unit 400 may include a housing 410 and a drive motor 420. The target platform controls 72 may be used to activate the drive motor 420 in order to transport the target carrier 80 to various locations along the track 440.

FIG. 4 is a side view of the firing lane 30 of FIG. 3, according to an embodiment of the present disclosure. The drive unit 400 is shown above and rearward within a firing position (see 40 in FIG. 3). In other embodiments, the drive unit 400 may be located elsewhere, including, but not limited to, outside the firing position 40. In some embodiments, the drive motor 420 is completely enclosed within the drive housing 410. The target platform 70 is coupled to and transported along the track 440. The track 440 is coupled at a proximal end to the drive motor 420, and at a distal end to the end pulley 444.

The track 440 may include a parking position 450 near the firing position 40. The parking position 450 may be sufficiently near the firing position 40 to permit a shooter to interact directly with a target 500 (e.g., attach a target 500 to the target platform 70 and/or the target carrier 80) from within the firing position 40. The parking position 450 may include a charger 240 and a power connector 242 to facilitate charging a battery pack (not shown, but see, e.g., battery pack 244 in FIG. 5). In another embodiment, the charger 240 may be within the target carrier 80. The power connector 242 is disposed so as to deliver the appropriate electrical service based on the location of the charger 240. The track 440 may include additional discrete positions (not shown) for specific firing distances from the firing position 40.

The floor 48 includes a firing line 32. The firing line 32 may extend perpendicular to a length of the firing lane 30, demarking a forward (down range) edge of the firing position 40. The firing line 32 may be painted on the floor 48, or otherwise suitably demarked. The shooter's bench 46 may be located within the firing position 40 so as to be convenient for supporting ammunition, tools, a firearm (while not being handled), etc. The shooter's bench 46 may be disposed such that it does not extend beyond the vertical plane of the firing line 32.

In FIG. 4, the left stall wall 42 is shown. The target platform controls 72 and ASES user interface 300 are shown as an integrated unit coupled to or integrated in the left stall wall 42. In some embodiments, the target platform controls 72 and ASES user interface 300 may be coupled to or integrated in the right stall wall (not shown, but see, e.g., right stall wall 44 in FIG. 3). In some embodiments, the target platform controls 72 and ASES user interface 300 may each comprise a distinct panel, and the panels may be disposed adjacent to each other. In other embodiments, the target platform controls 72 and ASES user interface 300 may be disposed in different locations away from each other.

The target platform 70 is shown at an indeterminate position along the track 440. The target carrier 80 couples to the track 440, and a target hanger 88 couples to the target carrier 80. A target 500 may couple to the target hanger 88 so as to be disposed below at least a portion of the target carrier 80. Coupling of the target 500 to the target hanger 88 may permit the target 500 to hang below the target platform 70 in a position that is fixed relative to the target platform 70 and the vision system (see 200 in FIG. 5).

FIG. 5 is a cross sectional view of the target carrier 80 of FIGS. 3 and 4. The target carrier 80 comprises a housing 82, one or more carrier wheels 84, one or more guide wheels 86, a target hanger clamp 89, a ballistic plate 90, and a vision system 200.

The carrier wheel(s) 84 and guide wheel(s) 86 may facilitate movement of the target carrier 80 along the track (not shown, but see, e.g., track 440 in FIG. 4). The ballistic plate 90 may protect the target carrier 80 and internal components from an impact by a bullet, or by bullet fragments or other objects (commonly known as “spatter”). The target hanger clamp 89 may couple a target hanger (not shown, but see, e.g., target hanger 88 in FIGS. 3 and 4) to the target carrier 80.

The vision system 200 may include an imaging device 210, a graphics processor 220, a processor 222, a transceiver 234, and a battery pack 244. A view opening 212 may permit the imaging device 210 a view through the housing 82 of a target (see target 500 in FIG. 2) hung from or otherwise coupled to the hanger clamp 89. The battery pack 244 may supply power to the imaging device 210, the graphics processor 220, the processor 222, and the transceiver 234. The transceiver 234 may comprise a transmitter and a receiver, and may include an antenna 236 located on or within the target carrier 80. In FIG. 5, the antenna 236 is depicted coupled near the target hanger clamp 89; however, the antenna 236 may be coupled to the target carrier 80 at any suitable location. The transceiver 234 of the vision system 200 may communicate with one or more other components of the ASES 100. For example, the transceiver 234 may communicate with the control computer 20 (see FIG. 2), the user interface 300 (see FIG. 4), etc.

In one embodiment, a charger 240 (see FIG. 4) may be coupled within the target carrier 80. In another embodiment, the charger 240 may be coupled at an exterior structure located at a parking position for the target carrier 80. A power connector 246 may be coupled at an upper region of the target carrier 80 to provide an electrical connection for the vision system 200. The power connector 246 can be situated so as to deliver the appropriate electrical service based on the location of the charger 240.

The imaging device 210 may comprise a digital camera or similar device. In FIG. 5, the imaging device 210 is shown near the ballistic plate 90; however, the imaging device 210 may be situated in any appropriate fixed location within the target carrier 80, such that the imaging device 210 remains fixed relative to a target coupled to the target hanger clamp 89. The view opening 212 is situated so as to permit the imaging device 210 an unobstructed view of a target suspended below the target carrier 80. The imaging device 210 is situated to capture an image of the target. The imaging device 210 may capture one or more images of the target at a fixed rate, for example, 30 images per second (or frames per second, FPS), 60 FPS, 120 FPS, etc.

The imaging device 210 may send raw (unprocessed or partially processed) digital image data to a graphics processor 220. The graphics processor 220 may be configured with firmware and/or software to enable the graphics processor 220 to perform predetermined manipulations to the digital image data. For example, the graphics processor 220 may perform a temporal smoothing process, as described elsewhere herein, to facilitate identification of a bullet hole on the target, compress the digital image data using a digital processing algorithm to reduce the amount of data to be transmitted and sent to the processor 222 or the transceiver 234, and/or perform other graphics-related functions.

In FIG. 5, the graphics processor 220 is distinct from the imaging device 210. In some embodiments, the graphics processor 220 may be incorporated into the imaging device 210. In an embodiment, the graphics processor 220 may be incorporated into the processor 222. Digital image data may be transferred from the graphics processor 220 to the processor 222 or to the transceiver 234, or both.

The vision system 200 may be activated by any of a number of predetermined events. By way of example without limitation, the vision system 200 may be activated by arrival of a shooter at a predetermined distance from the firing position (e.g., firing position 40 in FIG. 3), or by a predetermined signal generated by the control computer 20, or the user interface 300. A firing lane 30 may be equipped with a shot-fired detector (see shot-fired detector 460 in FIG. 6A). Detection of a first shot may activate the vision system 200. Once activated, the vision system 200 may continuously capture images of the target until any of several predetermined events transpires. For example, the vision system 200 may cease capturing images when the target carrier 80 moves away from the position at which the target carrier 80 was located when the vision system 200 was activated. As another example, the imaging device 210 may respond to a timer signal (originating either onboard the vision system 200 or from the control computer 20 or user interface 300) to capture images for a predetermined or selected duration. Other events may also be used to trigger cessation of image capture by the vision system 200.

The vision system 200 may transmit the image/series of images in the form of digital image data via the transceiver 234 of the vision system 200 to the control computer 20 or the user interface 300 in real time (or near real time). When the digital image data is sent to the control computer 20, the control computer 20 may manipulate the digital image data, store the digital image data on the data storage system 24 (see FIG. 2), send the digital data image (or the manipulated digital image data) to the user interface 300, etc.

In other embodiments, the target carrier 80 may be a stationary carrier (e.g., one that does not transport a target up range or down range). In still other embodiments, the target carrier 80 may be a stationary turning carrier (e.g., to rotate or turn the target). In still other embodiments, the target carrier 80 may transport a target up range or down range and turn the target. In any of the foregoing embodiments, the vision system 200 of the target carrier 80 may be coupled to the target carrier 80 at a fixed position relative to the target carrier 80 so as to be disposed in a fixed position relative to a target coupled to the target carrier 80, or otherwise capable of capturing image data of a target.

The target carrier 80 may be capable of receiving a target such that the target may be disposed orthogonal to the firing line 32. The target carrier 80 may be configured so as to articulate or rotate the target to be disposed parallel to the firing line 32. The articulation/rotation of the target may be accomplished upon a signal from the control computer 20 or user interface 300, or via a programmatic function of the processor 222 of the vision system 200. The target carrier 80 may be further configured so as to articulate or rotate the target back to the position orthogonal to the firing line 32 after a predetermined time, a predetermined number of shots fired, or a predetermined number of bullet holes appearing on the target, or upon a signal from the control computer 20 or user interface 300 or processor 222 of the vision system 200, etc.

FIG. 6A is a cross sectional side view of a drive unit 400 of the firing lane 30 of FIGS. 3-4, according to an embodiment of the present disclosure. The drive unit 400 comprises a housing 410 and a drive motor 420. A processor 422 may be coupled at the housing 410. Also coupled at the housing 410 may be a transceiver 434 and a power supply 430. The transceiver 434 may include an antenna 436. The antenna 436 is depicted coupled on a forward exterior portion of the housing 410; however, the antenna 436 may be coupled at any suitable location for connection to the transceiver 434.

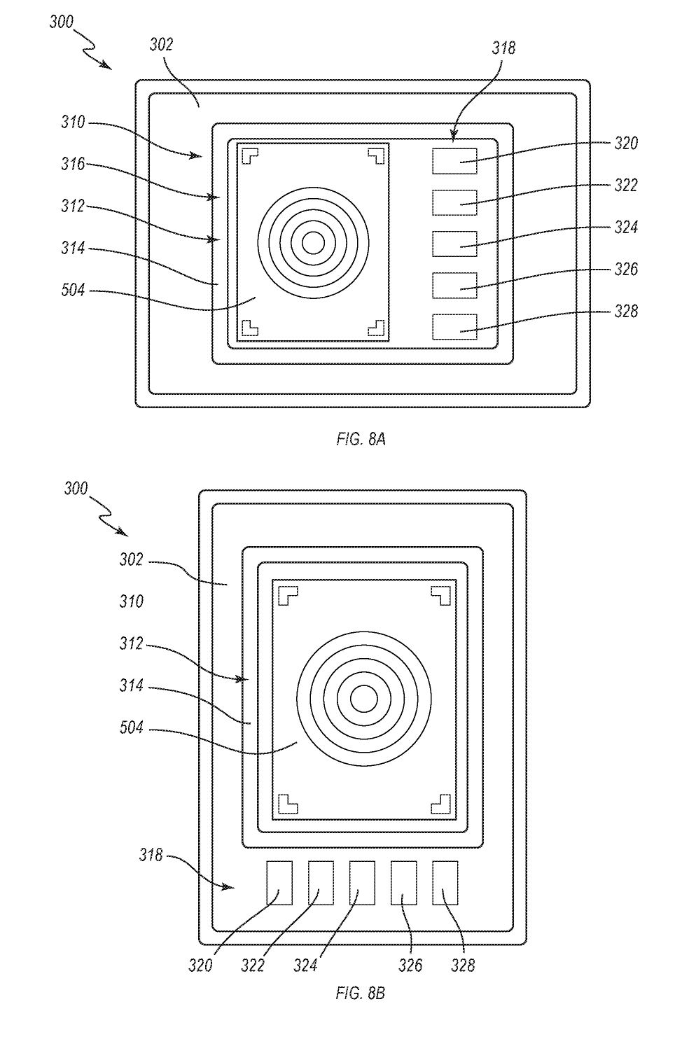

The processor 422 may have installed to it an operating system, firmware and software. In one embodiment, processor 422 may receive data from the control computer 20 (see FIG. 2) or the user interface (not shown, but see, e.g., user interface 300 in FIGS. 8A, 8B) to control operation of the target platform 70 (see FIG. 4). For example, a shooter may, by the user interface 300, instruct the processor 422 to interact with the target platform 70 to position the target carrier 80 with the target 500 a particular distance from the firing line 32 (see FIG. 4). During a competitive event, for example, the control computer 20 may send a signal to the processor 422 of a plurality of firing lanes 30 to interact with the target platform 70 to position the target carrier 80 of each such firing lane 30 at a particular distance from the firing line 32, and, further, to rotate the target 500 (into view) of every such firing lane 30 simultaneously to begin a shooting event, and, further, to re-rotate the target 500 (out of view) simultaneously to end the shooting event.

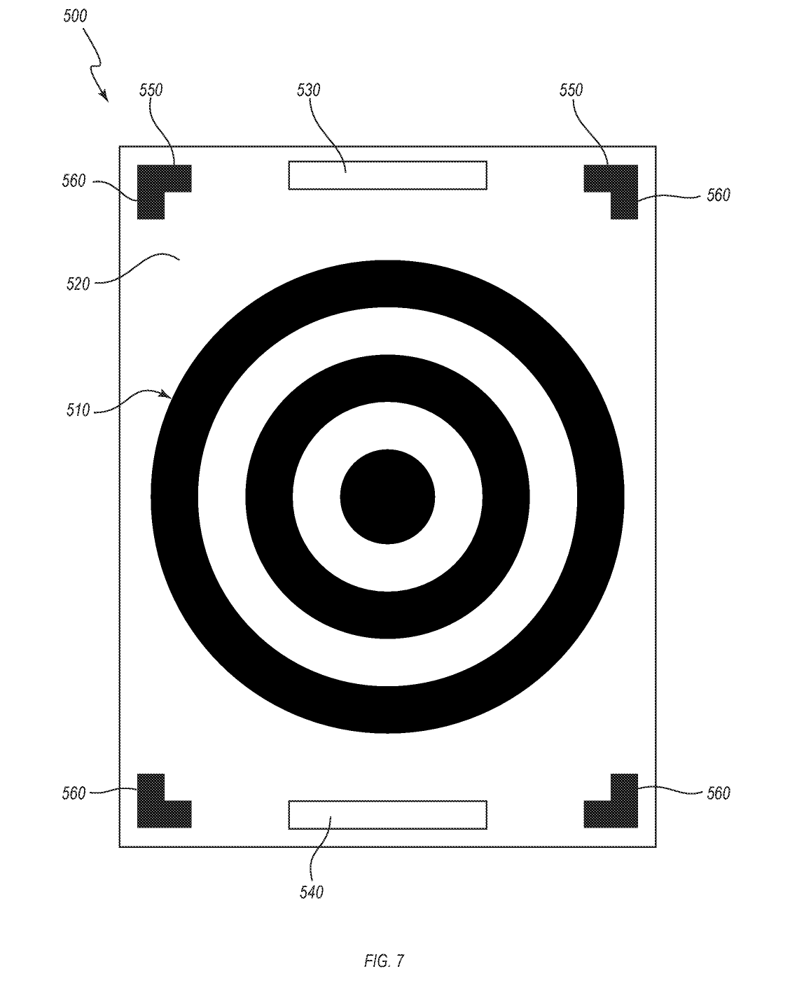

In one embodiment, the processor 422 may receive digital image data from the vision system (not shown, but see, e.g., 200 in FIG. 5). By means of the firmware and software, the processor 422 may identify or otherwise resolve one or more machine readable target identifiers (not shown, but see, e.g., machine readable target identifiers 550 in FIG. 7) to identify a target type, or even the specific target 500, suspended below the target carrier 80. In some embodiments, the firmware/software may permit the processor 422 to identify a target 500 absent the machine readable identifier 550 (a quasi-generic target identification). As the processor 422 processes the digital image information, the processor 422 may identify the appearance of a bullet hole on the target 500, or a subsequent bullet hole or holes, as described below. The processor 422 may then send data to the user interface 300. Communication between the processor 422 and the user interface 300 may be accomplished by means of physical cabling (not shown) or through the transceiver 434 to another transceiver (not depicted) connected to the user interface 300.

The firing lane 30 may be equipped with a shot-fired detector 460. The shot-fired detector 460 may comprise any one or more of an acoustic detection system, a laser detection system, or any other appropriate system for the detection of a shot fired. The shot-fired detector 460 is shown in FIG. 6A coupled at a portion of the housing 410 of the drive unit 400; however, the shot-fired detector 460 may be disposed in any suitable position or location to facilitate detection of shots fired from the firing position 40 of the particular firing lane 30.

FIG. 6B is a close-up side view of the processor 422 of FIG. 6A. A power supply cable 432, a transceiver cable 435, and a shot-fired detector cable 462 are shown for reference. The processor 422 may include a computer port 424. The computer port 424 may be a computer-industry standard port, such as, for example, a uniform serial bus (USB) port, a high definition multimedia interface (HDMI) port, or any other standard port. The processor 422 may include an external dongle 426 which comports to the port 424. The dongle 426 may include a hardware/software “key” to enable the processor 422 function. That is, the processor 422 may be configured such that the processor 422 cannot function above the operating system level absent the dongle 426 being installed into the port 424. The dongle 426 may serve to prevent unauthorized access to the hardware, firmware, and software onboard the processor 422, or to prevent unauthorized downloading of firmware or software from the processor 422.

The port 424 may also serve to allow connection of an external device (not shown) to upload firmware/software to the processor 422. For example, a firmware update for the invention herein disclosed may be uploaded to the processor 422 from an external device via the port 424. Such an external device may be required by the operating system onboard the processor 422 to embody the security function of the dongle 426 in order to upload/update firmware or software.

The dongle 426 may include a dongle tether 427. The dongle tether 427 may couple to the dongle 426 and the processor 422 at dongle tether anchors 428. The dongle tether 427 may allow the dongle 426 to be removed from the port 424 with minimal risk of losing the dongle 426. For example, the dongle 426 may be withdrawn from the port 424 to permit connection of an external device for updating software while permitting the dongle 426 to remain coupled to the processor 422 via the dongle tether 427 so that a range operator does not accidentally misplace the dongle 426.

FIG. 7 is a front view of a target 500 for use with the ASES 100, according to an embodiment of the present disclosure. The target 500 comprises a scoring region 510, a non-scoring region 520, and one or more identifiers 530, 540, 550, 560. The dimensions of the target 500, as well as the dimensions of the scoring region 510 and non-scoring region 520, may comport to standards for marksmanship of a shooting sports governing body. In other words, the target 500 may have the same width and height as a comparable target for the same weapon type, firing distance, and event type established by a cognizant governing body, such as, for example, the National Rifle Association (NRA), the International Shooting Sport Federation (ISSF), the International Military Sports Council (IMSC), etc. Similarly, the non-scoring region 520 and scoring region 510 may comport to standards established by such entities.

The target 500 may include a nomenclature region 530, a shooter data region 540, one or more machine readable target identifiers 550, and one or more machine readable target bounding indicators 560. The nomenclature region 530 may contain human-readable target identification information, including identification of applicable standards. For example, the nomenclature region 530 may indicate the name of the target manufacturer and licensing information, and indicate an applicable governing body standard. As a more specific example, the nomenclature region 530 may indicate the target 500 comports to NRA standards for slow fire pistol at 25 yards.

In one embodiment, the shooter data region 540 may be pre-printed on the target 500 as a series of blanks for hand entry of data such as, for example, a shooter's name, event, stage, date, etc. In one embodiment, the shooter data region 540 may comprise an adhesive label printed, for example, on the printer 22 and using shooter data from the data storage system 24 as accessed by a range operator 10 using the control computer 20 (see FIG. 2). Alternatively, the adhesive label may be printed by the shooter using a user interface similar to the user interface 300 but located, for example, at a check-in kiosk.

Both the nomenclature region 530 and shooter data region 540 may be human-readable, and may also be machine readable by use of optical character recognition. That is, in an embodiment, the nomenclature region 530 and shooter data region 540 may be ignored by the ASES 100 and, in another embodiment, may be readable by the ASES 100. For reference only, the nomenclature region 530 is depicted near the top-center of the target 500, and the shooter data region 540 is depicted near the bottom-center of the target 500; however, they may be placed in any suitable location on the target 500.

The target 500 may include one or more machine readable target identifiers 550. A single machine readable target identifier 550 may encode sufficient data to completely identify the target 500 to the ASES 100. Multiple machine readable target identifiers 550 may be affixed on a target 500 for redundancy and to ensure accuracy. In one embodiment, the machine readable target identifier 550 may comprise a target type, including target information such as size, firing distance, purpose, and scoring information. In one embodiment, the machine readable target identifier 550 may comprise a reference to an entry of a data base, such as the data storage system 24 (see FIG. 2), with the referenced entry including target information such as, by way of example without limitation, a target size, firing distance, purpose, and scoring information. In one embodiment, the machine readable target identifier 550 may, in addition to encoding either the target information or a reference to a data base entry, also comprise a data base reference to a record of an individual shooter.

The target 500 may include one or more machine readable target bounding indicators 560. The machine readable target bounding indicators 560 may be interpreted by the ASES 100 so as to determine the actual height and width of the target 500. The height and width data derived from the machine readable target bounding indicators 560 may augment the data encoded in the machine readable target identifier 550 to ensure accuracy of operation of the ASES 100. For example, the exact positioning of the machine readable target bounding indicators 560 may assist the ASES 100 in determining the orientation of the target 500 in the event the target 500 is accidentally hung off-vertical from the target carrier 80 (see FIGS. 3 and 4), or in determining that the target 500 is actually hung vertically below the target carrier 80.

While a bullseye target 500 is used throughout this disclosure, other target types are feasible and anticipated by the disclosure. For example, a silhouette target may be employed for police practical combat and self-defense courses, or an animal silhouette/image, as well as other target types, may be used. The machine readable target identifier(s) 550 and machine readable target bounding indicator(s) 560 may allow the ASES 100 to correctly interpret not only the type of the target 500 (from a group of target types), but also the exact orientation of the target 500 to the target carrier 80.

In FIG. 7, the placement and shape of the machine readable target identifiers 550 and machine readable target bounding indicators 560 are for reference only. The machine readable target identifier(s) 550 and machine readable target bounding indicator(s) 560 may take a shape appropriate for the data encoded and may vary by target size and type. Location of the machine readable target identifier(s) 550 and machine readable target bounding indicator(s) 560 may also vary by target size and type.

FIG. 8A is a front view of a user interface 300 of the ASES 100 comprising a touch screen, according to one embodiment of the present disclosure. FIG. 8B is a front view of a user interface 300 of the ASES 100 employing physical buttons rather than, or in addition to a touch screen, according to an embodiment of the present disclosure. Referring now to FIGS. 8A and 8B, the user interface 300 may comprise a bezel 302 and a display 310. The display 310 may comprise a display bezel 314 and a display screen 312. The display screen 312 may be able to operate in a variety of display modes, such as, for example, 16-bit color at 1,920 pixels by 1,080 pixels. The display screen 312 may be a touch screen. In a touch screen embodiment, the display screen 312 include a data display region 316 and a button region 318. The data display region 316 may display data in the form of text, images, or graphics, or any combination of these. The display 310 may receive data from the control computer 20 (see FIG. 2) or the processor 422 (see FIG. 6B) to control content rendered in the display 310.

The button region 318 of the display screen 312 may display one or more buttons 320-328. Each button 320-328 may be displayed as text, an image, a graphic, or a combination of these. Rendering and function of each button 320-328 may be controlled by data received at the display 310 from the control computer 20 or processor 422. A user may touch a button 320-328 to signal the ASES 100 to perform any of a set of display functions, to control a target carrier (see, e.g., target carrier 80 in FIGS. 1 and 2), or to perform any of a variety of shooting facility-related functions.

The display functions related to the ASES 100 may include commands such as, for example, to start or end a shooting session, to display results in real time for a shooting session, to display aggregate results of a shooting session, the manner of displaying results of a shooting session, etc. The target carrier control functions may include, for example, to send the target carrier 80 down range to a predetermined position, to return the target carrier 80 up range to a predetermined position (including returning the target carrier 80 to the parking position (see parking position 450 in FIG. 4)), or to move the target carrier 80 to a random position. (A random position may be a random selection from a group of distances predetermined by the range operator and complying to any applicable marksmanship standard.) Other target carrier functions may also be selected, as appropriate.

In some embodiments, the display screen 312 may incorporate only buttons having ASES-related functions. In such embodiments, control buttons for the target carrier 80 may be physical switches located in the bezel 302 of the user interface 300, or another appropriate location external to the user interface 300.

The number of buttons 320-328 shown at any time may vary according to the current state of the ASES 100 relative to the particular user interface 300 and function selected. Five buttons 320, 322, 324, 326, 328 are shown in the button region 318; however, there may be more than five or fewer than five buttons 320-328.

The user interface 300 may communicate with other components of the ASES 100 by fixed wiring (not shown) or by wireless communication. For wireless communication between the user interface 300 and another ASES 100 component, a wireless transceiver (not shown) and antenna (not shown) similar to those of the processor 422 (see 434 and 436 in FIG. 6A) and the vision system 200 (see 234 and 236 in FIG. 5) may be coupled at the user interface 300.

In FIG. 8A, the data display region 316 occupies approximately the left two-thirds of the display screen 312, and the button region 318 occupies approximately the right one-third of the display screen 312. These are for reference only, and the actual location and size of the data display region 316 and button region 318 may vary from one embodiment to another, or from one display function to another.

FIG. 8B illustrates one embodiment of a user interface 300 having a display 310 which includes a display screen 312 that is not a touch screen. In an embodiment of a user interface 300 without a touch screen display screen 312, the button region 318 may be a part or region of the bezel 302 of the user interface 300. In FIG. 8B, the button region 318 is in the lower region of the bezel 302, however, the button region 318 may be at any appropriate region of the bezel 302, or may be located adjacent to the bezel 302.

The buttons 320-328 may be labeled in any appropriate manner such that the display screen 312 may identify the function of each button. For example, the buttons 320-328 may be labeled, consecutively, A, B, C, D, E, and display 310 may indicate that the function of the button 320 (labeled “A”) is to cause the display 310 to show only the most recent shot result, for example, and the display screen 312 may indicate this function textually, such as, for example, “Press A for last shot.” The function of each button 320-328 may vary depending on the current state of the ASES 100 relative to the particular user interface 300, and such changes may be dynamically indicated on the display screen 312.

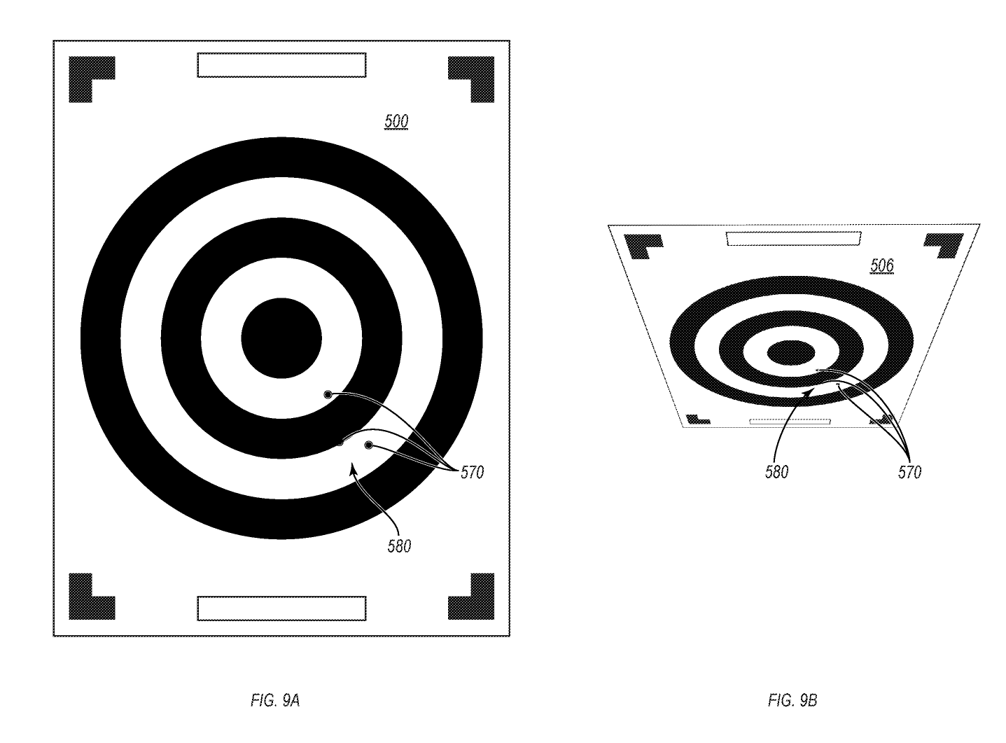

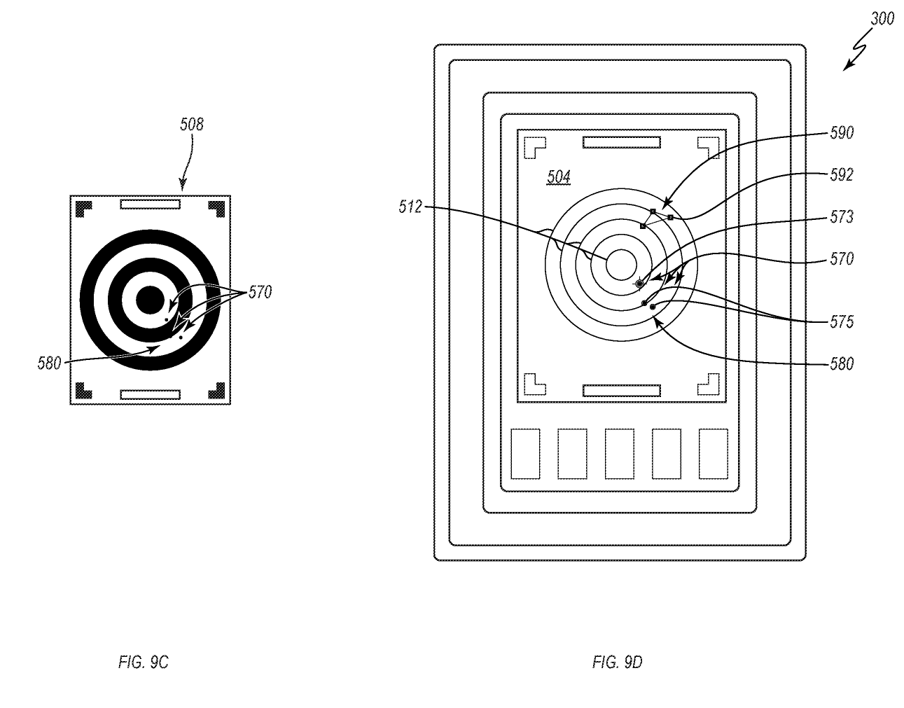

FIG. 9A is a front view of the target 500 having a group 580 comprising three bullet holes 570. FIG. 9B is a perspective view of the target 500 of FIG. 9A as viewed by the vision system 200 (see FIG. 5), according to an embodiment of the present disclosure. FIG. 9C is a perspective view of the target 500 of FIGS. 9A-9B from the view of a shooter at the firing position 40 of FIGS. 3-4. FIG. 9D is front view of the user interface 300 displaying a target analog 504 of the target 500 of FIGS. 9A-9C. FIG. 9A presents a referential (non-life-size) view of how the target 500 may appear with the group 580. FIG. 9B illustrates a downward-angled view of the target 500 as seen from a vantage point of the vision system 200 onboard the target carrier 80 to which the target 500 is coupled. The target 500, group 580, and bullet holes 570 are perspective-skewed. While the view of the group 580 and bullet holes 570 in FIG. 9B is not particularly useful to a shooter, the vision system 200 of the ASES 100 may be able to identify the bullet holes 570 with particular clarity and accuracy and provide data regarding the bullet holes 570 to the ASES 100 (for example, to the control computer 20 or the processor 422).

In FIG. 9C, the target 500 of FIG. 9A is shown at or near a size at which the target 500 would be viewable by a shooter at the firing position 40 with the target 500 still downrange. That is, the target 500 is presented as it may be viewed by the shooter immediately after firing the shots which created the bullet holes 570. As may be apparent from FIG. 9C, at least some information about the disposition of each bullet hole 570 may be vague or even imperceptible to a shooter without returning the target 500 up range to, for example, the parking position 450 (see FIG. 4). To move the target 500 up range so the shooter may better discern the bullet holes 570 necessitates at least interacting with the target platform controls 72 (see FIG. 4), which will cause the shooter to change at least a portion of the shooter's stance, and may involve placing the weapon on the shooter's bench 46 (see FIG. 4), turning the shooter's body, moving the shooter's feet, etc. In other words, many of the factors involved in producing the particular bullet holes 570 to be evaluated will change such that the utility of the evaluation may be significantly diminished as the shooter's stance, weapon grip, and body position are all likely to change as a result of the evaluation process.

In FIG. 9D, the target 500 may be rendered as the target analog 504 in the display 310 of the user interface 300 somewhat larger than the shooter's direct view of the target 500 (as in FIG. 9C). Furthermore, the target analog 504 may be shown with discreet rings 512 rather than the solid color-scoring regions of the actual target 500. Additionally, the ASES 100 may include distinct artifacts associated to each bullet hole 570 to assist the shooter in identifying each bullet hole 570, the position of each bullet hole 570, etc. For example, the display 310 of the user interface 300 may show the most recent bullet hole 570 with an artifact or glyph 573 which readily identifies to the shooter which bullet hole 570 represents the latest shot fired. The display 310 may render bullet holes 570 of the same group 580 but preceding the latest bullet hole 570 with a different artifact of glyph 575. The ASES 100 may automatically apply a series of identifiers, such as the glyphs 573, 575, and, further, may include a series indicator whereby the bullet holes 570 may be numbered in the order of firing. The display 310 may include a region of text with data about each bullet hole 570 associated by such a serial identifier. By way of example, the group 580 comprises three bullet holes 570. A first bullet hole 570 may be shown by the glyph 575, and may be accompanied by a numeral (not shown), such as “1” and associated to a textual area having the “1” and further including data such as the direction of the first bullet hole 570 from the center of the target 500, distance from the center of the target 500, and a point value of the first bullet hole 570. A second bullet hole 570 may be similarly denoted with the glyph 575 and accompanied by a numeral “2” associated to a textual report of the direction and distance of the second bullet hole 570 from the center of the target 500 and a point value. A most recent bullet hole 570 may be denoted by the glyph 573 and a numeral “3” and associated to a textual report of the direction and distance from the center of the target 500 and a point value.

The ASES 100 may be configured to identify a preferred number of shots/bullet holes 570 as belonging to a distinct group 580. Configuration of the number of bullet holes 570 to be associated to a distinct group 580 may be accomplished prior to a shooting event. The ASES 100 may be configured to accept a press of a button 320-328 (see FIGS. 8A-8B) to terminate a first group 580 and commence a subsequent group 580. Each bullet hole 570 and each group 580, in addition to being associated to the particular shooter, may be associated to a date and time of the shooting event, and may also be associated to a particular firearm used by the shooter to produce the bullet hole/group 570/580.

The ASES 100 may be further configured to render to the display 301 of the user interface 300 only the current group 580. The ASES 100 may also be configured to render to the display 310 a previous group 590. The previous group 590 may be a group 590 of bullet holes 592 of shots fired immediately prior to the current group 580. The previous group 590 may also be a group 590 fired at any previous time, or date and time, which has been stored to the data storage system 24 (see FIG. 2) and associated to the particular shooter. The ASES 100 may be configured to render to the display 310 multiple groups 590. The ASES 100 may be configured to render to the display 310 groups 580, 590 of multiple shooters. The groups 580, 590 may be rendered to a communal display (not shown) such as to a spectator display, a range operator display, a shooting event judge display, etc.

Each bullet hole 570 to be displayed may be derived by the ASES 100 from a collection of data, which are then processed by a processor before being sent to the user interface 300. The vision system 200 may capture a series of images of the target 500. The vision system 200, or the control computer 20, or the processor 422 at the firing position 40 may apply temporal smoothing, described below, to the series of images to identify the appearance of a bullet hole 570, analyze the location of each bullet hole 570 based on the machine readable target identifiers 550 and machine readable target bounding indicators 560, and display the result of each shot or series of shots in the display screen 312 of the user interface 300, to a spectator display, etc. In conjunction with data from the shot-fired detector 460 (see FIG. 6A), the ASES 100 may identify shots which completely miss the target 500, or bullet holes 570 which appear on the target 500 absent a shot fired from the associated firing position 40. In other words, the shot-fired detector 460 may signal to the ASES 100 that a shot was fired, the ASES 100 may determine from the vision system 200 that no bullet hole 570 appears on the target 500 within a predetermined time following the shot detection, and the ASES 100 may render to the display 310 a “miss” indicator and may also update any textual data area of the display 310 to indicate the missed shot. Similarly, if the vision system 200 provides data to the ASES 100 which the ASES 100 determines to present a new bullet hole 570 on the target 500 absent data from the shot-fired detector 460 within a predetermined time prior to the appearance of the bullet hole 570, the ASES 100 may identify the new bullet hole 570 as a crossfire from another firing lane 30. The ASES 100 may also identify the source of the crossfire by examining reports of shots fired by each shot-fired detector 460, in particular when the ASES 100 also identifies a “miss” on a target 500 in an appropriate time relative to the appearance of the crossfire bullet hole 570. The ASES 100 may render a crossfire glyph (not shown) to the display 310 of both the user interface 300 of the firing lane 30 where the crossfire bullet hole 570 is identified and the user interface 300 of the firing lane 30 determined to be the source of the crossfire. The ASES 100 may be able to display to a shooter the result of the shooter's most recent shot, or series of shots, thereby enabling the shooter to evaluate his or her current performance (precision and accuracy). Absent the ASES 100, a shooter may need to employ another means of examining the target 500 to determine the shooter's performance. Other means of evaluating shooter performance include retrieving the target carrier to the parking position, or examining the target 500 by means of a spotting scope or binoculars. In the former case, the target 500 itself may move relative to the target carrier while being advanced up range and returned down range for additional shooting. The need of the shooter to interact with controls to move the target carrier may require the shooter to change his or her physical stance relative to the target 500. Changes in a target's position or in the shooter's stance inherently change the way a shooter engages a target 500 or operates the weapon, or both. Similarly, trying to examine a target 500 through a spotting scope or binoculars will likely result in a change to the shooter's stance. Such changes in target position relative to a shooter, and in the shooter's stance, are significant to analyzing both accuracy and precision. That is, any attempt at analyzing a shooter's performance which causes a change in the target's position relative to the shooter, or in the shooter's stance, can be attenuated by those changes—meaning such analysis is flawed because the subsequent shooting is done under circumstances which, to some degree, are altered from those of the shots analyzed.

The ASES 100 may enable analysis of both accuracy and precision without the need to move the target 500 or to alter the shooter's stance. As such, the ASES may be able to report real-time data regarding a shooter's performance (accuracy and precision) in an environment in which subsequent shots occur under the same or nearly the same circumstances as the shots analyzed.

In addition to providing real-time analysis for a shooter, the ASES 100 may provide other services for the individual shooter, a plurality of shooters (as in a competition), and the shooting facility 1. For example, the ASES 100 may provide significantly faster (near real-time) scoring during competitive shooting. The ASES 100 may be able to provide observers, such as spectators, instructors, or event judges, with real-time or near real-time viewing of a shooter's performance through monitors (displays) away from the firing line. The ASES 100 may enable a range operator to respond to a shooter who has encountered a malfunction or other problem in that the shooter may be able to press a “call” button (320-328), or the ASES 100 may identify a potential problem through real-time analysis of shot-fired detectors 460.

The ASES 100 may store to the data storage system 24 data associated to a shooter over a period of time, enabling the shooter to monitor the shooter's performance. In other words, a shooter may use the ASES 100 to assist in improving the shooter's performance by reviewing historical data. Such historical data may be associated to the particular shooter, the date and time of the shooting event, the firearm employed, and may be further notated with additional information which may be relevant to the particular event. For example, the shooter may be able to permit an instructor to access the shooter's historical data to assist the shooter in improving the shooter's skill generally, with a particular shooting style, firearm, etc.

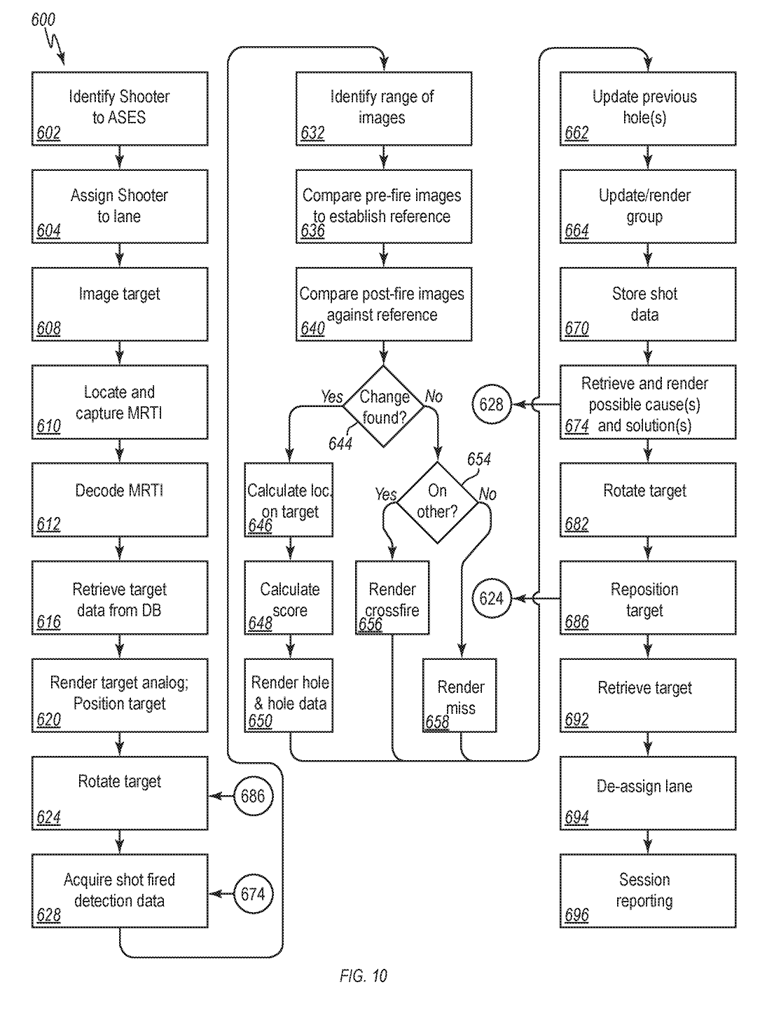

FIG. 10 is a flow diagram 600 of a method for automatically evaluating shooting performance, according to one embodiment. The method may be that of an ASES (e.g., ASES 100 of FIGS. 1-9D). An individual shooter is identified 602 to/by the ASES. If the individual shooter has an existing set of records associated to the individual shooter in the data storage system (e.g., data storage system 24 in FIG. 2), the previously stored records may be used to identify 602 the individual shooter to the ASES. An individual shooter having no previously existing records in the data storage system may create (or have created for him/her) an initial set of records to identify 602 the individual shooter to the ASES. The individual shooter may be assigned 604 to a firing lane (e.g., firing lane 30 in FIGS. 1, 3).

In one embodiment, (a) machine readable target identifier(s) (see machine readable target identifier 550 in FIG. 7) may be generated and printed and affixed to one or more targets (e.g. target 500 in FIGS. 1, 3, 7). A target may be coupled to the target carrier (see target carrier 80 in FIG. 3). The vision system (e.g., vision system 200 in FIG. 5) may be activated by, for example, the press of a button of a user interface (e.g., buttons 320-328, user interface 300 in FIGS. 3, 8A-8B) or by any other suitable activation. The vision system may image 608 the target (e.g., capture a first image, or begin capturing a series of images of the target). The vision system may further locate and/or capture 610 the machine readable target identifier(s) affixed to the target. In one embodiment, the vision system may decode 612 the machine readable target identifier (MRTI) to acquire information about the target, including a prescribed or recommended firing distance for the target. In another embodiment, the vision system may decode the machine readable target identifier to acquire a reference to a target data record in the data storage system of the ASES. In another embodiment, the vision system may send the machine readable target identifier, or decoded data of the machine readable target identifier to, for example, a processor (see processor 422 in FIG. 6A) and/or to a control computer (see control computer 20 in FIG. 2) to extract the target information or target data record reference from the machine readable target identifier. In an embodiment in which the machine readable target identifier is decoded 612 to acquire a target data record reference, the target data may be retrieved 616 from a data storage system.

After acquiring the target information, the ASES may render 620 a representation of the target to a display of a user interface. The ASES may also position 620 the target based on the target information, such as the firing distance for the target. In an embodiment of the present disclosure, the firing distance of the target may be overridden, or manually entered by the individual shooter via the user interface, or by a range operator using the control computer. In one embodiment, the target may be transported downrange with the target orthogonal to the a line (e.g., firing line 32 in FIG. 4). Once the target has been positioned 620 downrange, the ASES 100 may send a signal to the target carrier 80 to rotate 624 the target to face the individual shooter.

With the target positioned downrange and facing the individual shooter, the ASES is disposed to acquire data indicating a shot has been fired at the target, or that a new bullet hole has appeared on the target. The vision system may continuously capture image data of the target. The shot-fired detector (e.g. shot-fired detector 460 in FIG. 6A) may be disposed to exclusively recognize a shot fired from the firing position (e.g., firing position 40 in FIG. 3) of the firing lane to which the individual shooter has been assigned. When the shot-fired detector recognizes or otherwise detects a shot fired from the firing position, the ASES may acquire 628 the shot-fired detection data from the shot-fired detector.

Temporal smoothing of image data of the target may be utilized to identify changes to the target, and specifically new bullet holes in the target. The ASES may, based on the acquisition 628 of the shot-fired detection data, identify 632 a range of images of the vision system, including a plurality of images from before the shot-fired detection and/or one or more images after the shot-fired detection. The ASES may compare 636 the pre-fire images to derive a reference. The ASES may select a section of an image corresponding to an area in another image of the range of images where a difference is evidenced between the two images, and may compare the selected section to the difference-containing region, and may move the comparison selected section, pixel-wise or otherwise, across and around the difference-containing region or nearby regions to ascertain if the evidenced difference is something other than, for example, a result of the target moving. This may be repeated with each image of the range of images in order to minimize or even eliminate possible erroneous change detection to derive the reference, and to increase both accuracy and confidence in the change detection of the temporal smoothing process. The derived reference may represent a condition of the target prior to detection of the shot-fired detector. The one or more post-fire image(s) of the target may then be similarly compared 640 to the derived reference to ascertain 644 whether the target has undergone a change from the reference, such as a change that is the result of an impact from a bullet, ergo, a new bullet hole.

If the ASES identifies 644 a change that is a new bullet hole, the ASES may calculate 646 or otherwise determine the location of the new bullet hole on the target. More particularly, the ASES, in at least one embodiment, may calculate 646 a coordinate position on the target of the center of the new bullet hole. The ASES may calculate 648 a score value for the new bullet hole based on the coordinate position of the center of the bullet hole, a caliber (diameter) of a projectile (bullet) forming the new bullet hole, and the scoring configuration of the target as contained in the target information. The ASES may then send data to the user interface to enable rendering 650 the new bullet hole as a mark superimposed over the representation of the target (e.g. FIG. 9D).

If the ASES determines 644 that there is not a new bullet hole on the target within an appropriate time following acquisition 628 of the shot-fired detection data, the ASES may examine relevant data of other vision system(s) and shot-fired detector(s) of nearby firing lanes to determine 654 if a new bullet hole appeared on a nearby target that correlates to the shot-fired detection data of the firing lane of the individual shooter. If the ASES identifies a new bullet hole correlating to the shot-fired detection data for the individual shooter on a different target, the ASES may render an indicator of crossfire 656 to the display of the user interface.

If the ASES locates no new bullet hole on a target of any firing lane of the ASES correlating to the shot-fire detection data, the ASES may render an indicator of a miss 658 to the display of the user interface. Once the shot-fired detection data has been correlated to (a) a new bullet hole on the target 500, (b) a new bullet hole on another target, or (c) a miss, any rendered data relating one or more previous bullet holes may be updated 662 in the display. The ASES may also render or update 664 a group representation in the display. A first group may be identified when an individual shooter fires a first shot (including a crossfire or miss), and may be updated by adding subsequent shots (including crossfires and misses) to the first group. The ASES may transition from a first group to a second group when, for example, the individual shooter has fired a set number of shots, a set duration has passed, the individual shooter presses a designated button of the user interface, etc.

The ASES stores 670 the data of the latest shot, including new bullet hole data or crossfire/miss data, to the data storage system. The data of the latest shot may correlate the latest shot to the individual shooter, and may include such information as data and time, firearm used, target data, etc.

In one embodiment, the ASES may, based on the coordinates of the bullet hole on the target, retrieve 674 from a set of records of the data storage system one or more possible causes resulting in the bullet striking the target at the coordinates of the bullet hole, possible solution(s) for the possible cause(s), and may render the possible cause(s) and solution(s) to the display. The ASES (and the individual shooter) may repeat this process from the point of acquiring 628 shot-fired detection data. The ASES may rotate 682 the target out of view of the individual shooter after a predetermined time. The predetermined time may be found in the target information, such as may be retrieved in the target data record of the data storage system, or may be set by the individual shooter via the user interface, or by a range operator using the control computer.

An individual shooter may cause the ASES to move or reposition 686 the target at a different firing distance, after which, the ASES (and the individual shooter) may repeat the process from rotating 686 the target into view of the individual shooter. When the individual shooter has completed a shooting stage, event, or session, the target may be retrieved 692. The ASES may de-assign 694 the firing lane from the individual shooter. For example, if the individual shooter has finished for the day, the individual shooter may, via the user interface, indicate to the ASES that the individual shooter has finished, or a range operator may do so from the control computer. Optionally, the individual shooter may view 696 a shooting session report.

During a competitive event, the method of the ASES may be similar, with a number of features particularly suited to competitive shooting events. For example, a number of individual shooters may be assigned each to a discrete firing lane. The target for each individual shooter may have affixed to it a machine readable target identifier correlating the target to the individual shooter and, optionally, the competition, the stage, etc. Each target may be coupled to the firing lane of each individual shooter. All targets may be positioned at the firing distance for the particular stage, event or competition, and may be simultaneously rotated into view of the individual shooters, and again rotated out of view of the individual shooters at the expiration of time for, or completion of the stage or event. The ASES may render to the display of each firing lane assigned to a competing individual shooter a countdown timer to count down time until the targets are rotated into view, and a count down until the targets are rotated out of view. Each user interface may be disposed to allow a competitive shooter to signal, by a button a not-ready condition, which may, depending on the conditions of the competition, permit a delay in starting a stage or event. The ASES 100 may, in addition to providing shot data to each display of a firing lane assigned to a competing individual shooter, render similar data to other displays, for example, to a display for spectators, a display for judges, etc. The ASES may also aggregate scores of shots for individual shooters in a single stage, across multiple stages, or for an event; render, in real time or near real time, the aggregate scores to one or more displays. The ASES may also aggregate and render scores for teams of shooters. Other features and functions for competitive, group, or training events are anticipated by the present disclosure, as well.

The present disclosure further contemplates embodiments of methods of automated evaluation of performance of a shooter. The methods can include capturing current image data of a target and processing the image data to identify changes from previous image data to detect one or more added bullet holes. The method can include transmitting the image data to a user interface. The method can also include transmitting information about the target, including information identifying or otherwise specifying a specific target or a target type and information concerning a distance of the target from a firing line. The method can include displaying on the user interface a visual representation of the target and the additional bullet holes. The method can include displaying on the user interface information about the target, including the target type and distance of the target. The method can include determining and/or calculating a score indicative of the performance of the shooter.

### Example Embodiments

Some examples of embodiments of systems and methods of automated shooting evaluation are provided below.

Example 1. An automated shooting evaluation system (“ASES”), comprising a vision system to capture image data of a target secured by a target carrier, the vision system coupled in a fixed position to the target carrier and comprising an image capture device; one or more processors to process image data captured by the image capture device to identify a change to the target determined to be a new bullet hole, wherein the change to the target is identified by comparing a current image of the target to a plurality of prior images of the target; and a transmitter to transmit bullet hole data of the new bullet hole, the bullet hole data comprising coordinates with reference to the target; and a user interface to receive transmitted bullet hole data and to render a bullet hole indicator representative of the new bullet hole and superimposed on a representation of the target. The vision system can capture images, either individually or as a video stream, to provide to one or more processors. The one or more processors can compare a current image (or frame of video), to a series of previous images and, by application of temporal smoothing, identifying a change to the target that constitutes a new bullet hole. The one or more processors can further identify information such as coordinates relative to the target the position of the bullet hole on the target, and can transmit the information to a display to render a representation of the target with a marker representing the location of the bullet hole.

Example 2. The system of example 1, wherein the one or more processors further processes the image data to identify a machine readable target identifier of the target.

Example 3. The system of example 2, wherein the machine readable target identifier comprises a reference to a target data record for the target, the target data record stored in a data storage system and comprising one or more of a target size, a target distance, a target usage, and target scoring information.

Example 4. The system of example 2, wherein the machine readable target identifier comprises one or more of the target size, the target distance, the target usage, and the target scoring information.

Example 5. The system of example 1, further comprising a data storage system comprising one or more storage devices to receive, store, and deliver data of the automated shooting evaluation system.

Example 6. The system of example 5, wherein the data of the automated shooting evaluation system comprises a target data library comprising a plurality of records, each record associated to a target and including target information.

Example 7. The system of example 6, wherein the target information comprises information about the associated target, including one or more of target dimensions, target purpose, target range, and target scoring information.

Example 8. The system of example 1, further comprising a control computer in electrical communication with the vision system, the target carrier, a data storage system, and the user interface, the control computer to present a user profile record for access by the vision system and the user interface, the user profile record corresponding to an individual shooter; and store bullet hole data of the individual shooter in association with the user profile record.

Example 9. The system of example 1, further comprising a shot-fired detector to detect whether a shot is fired at the target.

Example 10. The system of example 9, wherein the shot-fired detector transmits shot-fired detection data that is used to determine that the change to the target is a new bullet hole.

Example 11. An automated shooting evaluation system (“ASES”), comprising a vision system to capture image data of a target secured by a target carrier, the vision system coupled in a fixed position to the target carrier and comprising an image capture device; one or more processors to process image data captured by the image capture device to identify a machine readable target identifier of the target and to identify changes to the target determined to be new bullet holes wherein a change to the target is identified by comparing a current image of the target to a plurality of prior images of the target; and a transmitter to transmit the machine readable target identifier and to transmit bullet hole data of new bullet holes, the bullet hole data comprising coordinates of a new bullet hole with reference to the target.

Example 12. The system of example 11, further comprising a user interface to receive transmitted bullet hole data and to render a bullet hole indicator representative of the new bullet hole and superimposed on a representation of the target.

Example 13. The system of example 11, wherein the machine readable target identifier comprises a reference to a target data record for the target, the target data record stored in a data storage system and comprising one or more of a target size, a target distance, a target usage, and target scoring information.

Example 14. The system of example 11, wherein the machine readable target identifier comprises one or more of the target size, the target distance, the target usage, and the target scoring information.

Example 15. The system of example 11, further comprising a data storage system comprising one or more storage devices to receive, store, and deliver data of the automated shooting evaluation system.

Example 16. The system of example 15, wherein the data of the automated shooting evaluation system comprises a target data library comprising a plurality of records, each record associated to a target and including target information.

Example 17. The system of example 16, wherein the target information comprises information about the associated target, including one or more of target dimensions, target purpose, target range, and target scoring information.

Example 18. The system of example 11, further comprising a control computer in electrical communication with the vision system, the target carrier, a data storage system, and the user interface, the control computer to present a user profile record for access by the vision system and the user interface, the user profile record corresponding to an individual shooter; and store bullet hole data of the individual shooter in association with the user profile record.

Example 19. The system of example 11, further comprising a shot-fired detector to detect whether a shot is fired at the target.

Example 20. The system of example 19, wherein the shot-fired detector transmits shot-fired detection data that is used to determine that the change to the target is a new bullet hole

Example 21. A method for automatically evaluating shooting performance, the method comprising capturing image data of a target using a vision system mounted in a fixed position relative to a target carrier securing the target; processing the image data, by one or more processors, to identify a change to a target, wherein the change to the target comprises a new bullet hole and is identified by comparing a current image of the target with a plurality of prior images of the target; transmitting bullet hole data of a new bullet hole; rendering on a display a mark representing the new bullet hole, based on the bullet hole data, wherein the mark is superimposed on a representation of the target; and wherein the target.

Example 22. The method of example 21, processing the captured image data to identify a machine readable target identifier on the target; identifying the target automatically by the vision system, based on the machine readable target identifier and determining information about the target from the machine readable target identifier.

Example 23. The method of example 22, wherein the information about the target includes one or more of a target size, a target distance, a target usage, and a target scoring.

Example 24. The method of example 22, further comprising: accessing from a data storage system a target record of a target data library, the target record selected for access based on one of the machine readable target identifier and the information about the target; rendering on the display a score based on the new bullet hole, the score determined based on the information about the target.

Example 25. The method of example 24, wherein the target data library comprises a plurality of records each associated to a target and including one or more of a target size, a target distance, a target usage, and a target scoring information.

Example 26. The method of example 21, further comprising storing information about the new bullet hole to a shot data record in a data storage system.

Example 27. The method of example 26, further comprising associating the shot data record to a user profile record corresponding to the shooter.

Example 28. The method of example 21, further comprising detecting whether a shot fired is fired at the target; and transmitting shot-fired detection data to determine that the change to the target is a new bullet hole.

Example 29. The system of example 2, wherein the machine readable target identifier associates a target to a particular course of marksmanship, the course of marksmanship being one or more of a training event, training system, competitive event, portion of a competitive event, and an event of a competitive series.

Example 30. The system of example 1, further comprising the target carrier to secure the target, wherein the target carrier is movable to transport the target.

Example 31. The system of example 30, wherein the vision system is coupled to the target carrier.

Example 32. The system of example 1, wherein the user interface comprises a receiver to receive the transmitted bullet hole data, and a display to render a representation of the target and the bullet hole indicator.

Example 33. The system of example 5, wherein the data comprise a target data library, the target data library comprising a plurality of records, each record associated to a particular target, a machine readable target identifier associated to the particular target, target dimensions, target purpose, target range, target scoring information.

Example 34. The system of example 5, wherein the data comprise a shooter data library, the shooter data library comprising a plurality of records, each record associated to an individual shooter and comprising firearm data, target data, shooting performance data of the individual shooter including historical shooting performance data.

Example 35. The system of example 1, further comprising a control computer in electrical communication with the vision system, the target carrier, a data storage system, and the user interface, the control computer to associate an individual shooter to the vision system and the user interface; associate the individual shooter to the bullet hole data; associate the individual shooter to a collection of records in the data storage system, and store, by the data storage system, the bullet hole data associated to the individual shooter.

Example 36. The system of example 35, wherein the control computer receives bullet hole data from the vision system.

Example 37. The system of example 35, wherein the control computer transmits bullet hole data to the user interface.

Example 38. The system of example 35, wherein the control computer receives identifying data regarding a shooter and assigns the shooter to a shooting position.

Example 39. The system of example 1, wherein the automated shooting evaluation system directs movement of the target carrier to a distance from a firing line.

Example 40. The system of example 39, wherein the distance is one of a distance determined from the machine readable target identifier and a distance entered by a shooter or a range operator.

Example 41. The system of example 39, wherein the automated shooting evaluation system can cause the target carrier to transport the target in such a manner that a face of the target is constantly exposed to a firing position.

Example 42. The system of example 39, wherein the automated shooting evaluation system can cause the target carrier to articulate so as to expose the face of the target to a firing position and can cause the target carrier to again articulate so that the face of the target is not exposed to the firing position.

Example 43. The system of example 35, wherein the control computer transmits shooter data to the data storage system for association with a profile of an individual shooter, wherein the shooter data comprises one or more of a date, a time, bullet hole data, firearm data, and target data.

Example 44. The system of example 35, wherein the control computer coordinates a multi-shooter shooting event by interfacing with a plurality of vision systems.

Example 45. The system of example 44, wherein the control computer causes a plurality of target carriers to transport targets; and, from bullet hole data received from the plurality of vision systems, evaluates bullet holes on a plurality of targets; and renders to one or more displays the result of bullet hole evaluation.

Example 46. The system of example 44, wherein the control computer causes the plurality of target carriers to simultaneously articulate targets into or out of view of firing positions.

Example 47. The system of example 34, wherein an individual shooter may retrieve data stored on the data storage system and associated to the individual shooter.

Example 48. The system of example 2, wherein the machine readable target identifier associates a target to a particular course of marksmanship, the course of marksmanship being one or more of a training event, training system, competitive event, portion of a competitive event, and an event of a competitive series.

Example 49, The system of example 11, wherein the machine readable target identifier associates a target to a particular course of marksmanship, the course of marksmanship being one or more of a training event, training system, competitive event, portion of a competitive event, and an event of a competitive series.

Example 50. The system of example 1, wherein the user interface comprises one or more of physical buttons and interactive buttons of a touch screen display whereby a shooter interacts with user interface.

Example 51. The system of example 19, wherein the shot-fired detector comprises an infrared sensor.

Example 52. The system of example 19, wherein the shot-fired detector comprises an acoustic sensor.

Example 53. The system of example 19, wherein the shot-fired detector comprises a laser sensor.

Example 54. The system of example 19, wherein the shot-fired detector comprises a plurality of sensors, the sensors being one or more of an acoustic sensor, an infrared sensor, and a laser sensor.

Example 55. The system of example 32, wherein the user interface is configured to display a new bullet hole indicator when a vision system reports a new bullet hole within a particular time of a shot being detected by a shot-fired detector; display a non-impact indicator when a vision system fails to report a new bullet hole within a particular time of a shot being detected by a shot-fired detector; display a cross-fire indicator when a vision system reports a new bullet hole absent a shot being detected by a shot-fired detector within a particular time prior to the appearance of the new bullet hole.

Example 56. The system of example 2, wherein the machine readable target identifier is incorporated to a target at the time of manufacture.

Example 57. The system of example 2, wherein the machine readable target identifier is applied to the target in the form of a post-manufacture label.

Example 58. The system of example 11, wherein the machine readable target identifier is incorporated to a target at the time of manufacture.

Example 59. The system of example 11, wherein the machine readable target identifier is applied to the target in the form of a post-manufacture label.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure. Thus, it is to be understood that the embodiments described above have been presented by way of example, and not limitation.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

The term “coupled to” is used in the ordinary sense, and is broad enough to refer to any suitable coupling or other form of interaction between two or more entities, including mechanical and fluid interaction. Two components may be coupled to each other even though they are not in direct contact with each other. The phrase “attached to” refers to interaction between two or more entities that are in direct contact with each other and/or are separated from each other only by a fastener of any suitable variety (e.g., mounting hardware or an adhesive).

The term “connect” is used in the sense common to the field of computer sciences, and represents the logical or physical coupling of two or more computer entities to transmit, receive or exchange electronic data. Computer entities may be subcomponents within a single computing system, or distinct computing systems, or components within a computing network. Computer entities may be connected by physical coupling (“wired,” “hardwired”) or radio transmission (“wireless”). For example, a display may be both coupled to and connected to a computer processor, or the display may be connected to a computer processor while being located elsewhere, hence, not coupled to the computer processor.

Recitation in the claims of the term “first” with respect to a feature or element does not necessarily imply the existence of a second or additional such feature or element.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

It will be apparent to those having skill in the art that changes may be made to the details of the above-described embodiments without departing from the underlying principles of the present disclosure. Embodiments of the disclosure in which an exclusive property or privilege is claimed are defined as follows.

1. An automated shooting evaluation system, comprising:
a vision system to capture image data of a target secured by a target carrier, the vision system coupled in a fixed position to the target carrier and comprising:
an image capture device;
one or more processors to process image data captured by the image capture device to identify a change to the target determined to be a new bullet hole, wherein the change to the target is identified by comparing a current image of the target to a plurality of prior images of the target; and
a transmitter to transmit bullet hole data of the new bullet hole, the bullet hole data comprising coordinates with reference to the target; and
a user interface to receive transmitted bullet hole data and to render a bullet hole indicator representative of the new bullet hole and superimposed on a representation of the target.

2. The system of claim 1, wherein the one or more processors further processes the image data to identify a machine readable target identifier of the target.

3. The system of claim 2, wherein the machine readable target identifier comprises a reference to a target data record for the target, the target data record stored in a data storage system and comprising one or more of a target size, a target distance, a target usage, and target scoring information.

4. The system of claim 2, wherein the machine readable target identifier comprises one or more of the target size, the target distance, the target usage, and the target scoring information.

5. The system of claim 1, further comprising a data storage system comprising one or more storage devices to receive, store, and deliver data of the automated shooting evaluation system.

6. The system of claim 5, wherein the data of the automated shooting evaluation system comprises a target data library comprising a plurality of records, each record associated to a target and including target information.

7. The system of claim 6, wherein the target information comprises information about the target, including one or more of target dimensions, target purpose, target range, and target scoring information.

8. The system of claim 1, further comprising a control computer in electrical communication with the vision system, the target carrier, a data storage system, and the user interface, the control computer to:
present a user profile record for access by the vision system and the user interface, the user profile record corresponding to an individual shooter; and
store bullet hole data of the individual shooter in association with the user profile record.

9. The system of claim 1, further comprising a shot-fired detector to detect whether a shot is fired at the target.

10. The system of claim 9, wherein the shot-fired detector transmits shot-fired detection data that is used to determine that the change to the target is a new bullet hole.

11. An automated shooting evaluation system, comprising:
a vision system to capture image data of a target secured by a target carrier, the vision system coupled in a fixed position to the target carrier and comprising:
an image capture device;
one or more processors to process image data captured by the image capture device to identify a machine readable target identifier of the target and to identify changes to the target determined to be new bullet holes wherein a change to the target is identified by comparing a current image of the target to a plurality of prior images of the target; and
a transmitter to transmit the machine readable target identifier and to transmit bullet hole data of new bullet holes, the bullet hole data comprising coordinates of a new bullet hole with reference to the target.

12. The system of claim 11, further comprising a user interface to receive transmitted bullet hole data and to render a bullet hole indicator representative of the new bullet hole and superimposed on a representation of the target.

13. The system of claim 11, wherein the machine readable target identifier comprises a reference to a target data record for the target, the target data record stored in a data storage system and comprising one or more of a target size, a target distance, a target usage, and target scoring information.

14. The system of claim 11, wherein the machine readable target identifier comprises one or more of the target size, the target distance, the target usage, and the target scoring information.

15. The system of claim 11, further comprising a data storage system comprising one or more storage devices to receive, store, and deliver data of the automated shooting evaluation system.

16. The system of claim 15, wherein the data of the automated shooting evaluation system comprises a target data library comprising a plurality of records, each record associated to a target and including target information.

17. The system of claim 16, wherein the target information comprises information about the associated target, including one or more of target dimensions, target purpose, target range, and target scoring information.

18. The system of claim 11, further comprising a control computer in electrical communication with the vision system, the target carrier, a data storage system, and the user interface, the control computer to:
present a user profile record for access by the vision system and the user interface, the user profile record corresponding to an individual shooter; and
store bullet hole data of the individual shooter in association with the user profile record.

19. The system of claim 11, further comprising a shot-fired detector to detect whether a shot is fired at the target.

20. The system of claim 19, wherein the shot-fired detector transmits shot-fired detection data that is used to determine that the change to the target is a new bullet hole.

21-27. (canceled)
